(19) United States
(12) Patent Application Publication
(10) Pub. No.: US 2012/0084653 A1
(43) Pub. Date: Apr. 5, 2012

(54) SYSTEM AND METHOD FOR CONTENT RENDERING CONTROL

(75) Inventors: Kalyana Kota, San Diego, CA (US); Guru Balasubramanian, San Diego, CA (US); Tanmay Agnihotri, San Diego, CA (US)

(73) Assignee: Sony Corporation, Tokyo (JP)

(21) Appl. No.: 12/896,777

(22) Filed: Oct. 1, 2010

(51) Int. Cl. G06F 3/01

(52) U.S. Cl. 715/720; 375/E07.076; 386/E05.003

(57) ABSTRACT

A system and method for controlling content rendering. The method includes rendering at a display device a content signal received on a predetermined input and sourced from a computer system and receiving at the display device a content rendering control command from a remote control device. The method further includes translating the content rendering control command to a media player control command recognizable by a media playback application of the computer system and sending the media player command to the computer system over a communication network to alter the content signal.

### FIELD OF THE INVENTION

Embodiments of the present invention are generally related to controlling content rendering, e.g., related to an audio/video system.

### BACKGROUND OF THE INVENTION

As computers have advanced, they are increasingly being used for playing various types of media, such as movies, music and images. Similarly, the increasing availability and advantages of digital formats have made computers well suited for playback of digital content. Digital content thus allows consumers to easily view movies where and when they want.

While computers are well suited for playing movies, often the screens connected to the computer are of limited size, especially when compared to the size of televisions most consumers have in their home theaters or living rooms. In addition, desktop computers are usually located on a desk or table, away from couches and other comfortable furniture most suited for extended viewing. Laptops have even smaller screens than desktops thereby making movie viewing from a distance particularly difficult. This has caused consumers to use the video outputs from computer systems to connect to televisions to display digital content on the television.

Unfortunately, while connecting the computer system output to the television allows movies to be played on the larger screen of the television, whenever a user wants to pause or rewind or otherwise alter the playback of a movie, the user needs to get up and go to the computer. This is very inconvenient for the user and can disrupt the movie watching experience. The result is a sub-optimal viewing experience.

### SUMMARY OF THE INVENTION

Thus, a need exists for a system that allows content rendering control on a computing system without requiring the viewer to go to the computer system to enter each command. Embodiments of the present invention allow content rendering control by a computing system from a remote control device, much like a normal television experience. Controlling content rendering from the remote control removes the need for a viewer to go over to the computer system thereby providing an optimal viewing experience. Embodiments of the present invention further provide greater ease of use than using a pointing device of the computer system (e.g., the computer mouse, wireless mouse) or any other devices.

In one embodiment, the present invention is implemented as a method for remote media player control. The method includes rendering at a display device a content signal on a predetermined input (e.g., HDMI, VGA) and sourced from a computer system and receiving at the display device a content rendering control command (e.g., a remote control command code) from a remote control device. The content rendering control command may be any playback control, e.g., stop, play, pause, fast-forward, rewind, full screen, next playlist item, and previous playlist item command. The method further includes translating the content rendering control command to a media player control command recognizable by a media playback application of the computer system. The media player command can then be sent to the computer system over a communication network to alter the content signal. An acknowledgement signal indicating that the media playback application performed the media player command may then be received if the media player command was performed successfully by the computer system. If an acknowledgement is not received within a given time, notification may be displayed that the media player command was not successful.

In one embodiment, the present invention is implemented as a system for remote media player control. The system includes a media player detection module operable to detect an active media player application and a command receiving module operable to receive a media player control command from a display device which originated from a remote control device. The system further includes a command translation module operable to translate the media player control command to a control command for the active media player application and a media player signaling module operable to send the control command to the active media player application for execution thereof. In one embodiment, the command receiving module is operable to receive the media player control command via at least one of a wired computer network and a wireless computer network. The system may further include an operating system signaling module operable to send the control command to an operating system of a computer system. In one embodiment, the media player signaling module is operable to send the control command to the active media player application via an operating system call.

In another embodiment, the present invention is implemented as a computer readable media comprising instructions that when executed by an electronic system implement a method of remote control of content rendering. The method includes detecting, within a display device, a content signal received on a predetermined input (e.g., HDMI, VGA) and sourced from a computer system and receiving at the display device a content rendering control command (e.g., a remote control command code) from a remote control device. The content rendering control command may be any playback command, e.g., a stop, play, pause, fast-forward, rewind, full screen, next playlist item, and previous playlist item command. The method further includes translating the content rendering control command to a media player control command recognizable by a media playback application of the computer system and sending the media player command to the computer system over a communication network to alter the content signal. An acknowledgement may then be received if the media player command was performed successfully. If an acknowledgement is not received within a given time, notification may be displayed that the media player command was not successful.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a diagram of an exemplary flow of commands and content in accordance with one embodiment of the present invention.

FIG. 2 shows exemplary components for remote media player control in accordance with one embodiment of the present invention.

FIG. 3 shows exemplary components of a display device in accordance with one embodiment of the present invention.

FIG. 4 shows exemplary components of an operating environment for remote media player control in accordance with one embodiment of the present invention.

FIG. 5 shows exemplary components of a remote media player control module in accordance with one embodiment of the present invention.

FIG. 6 shows a flowchart of an exemplary computer controlled process for receiving a control command in accordance with one embodiment of the present invention.

FIG. 7 shows a flowchart of an exemplary computer controlled process for media player control in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

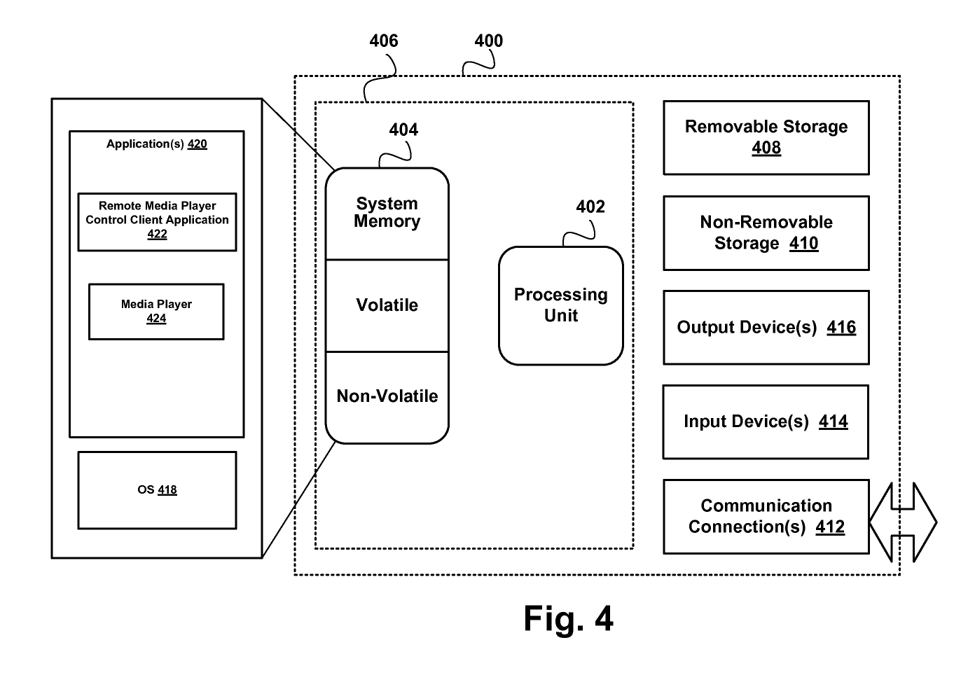

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a system having computing functionality (e.g., system 400 of FIG. 4), or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Systems and Methods:

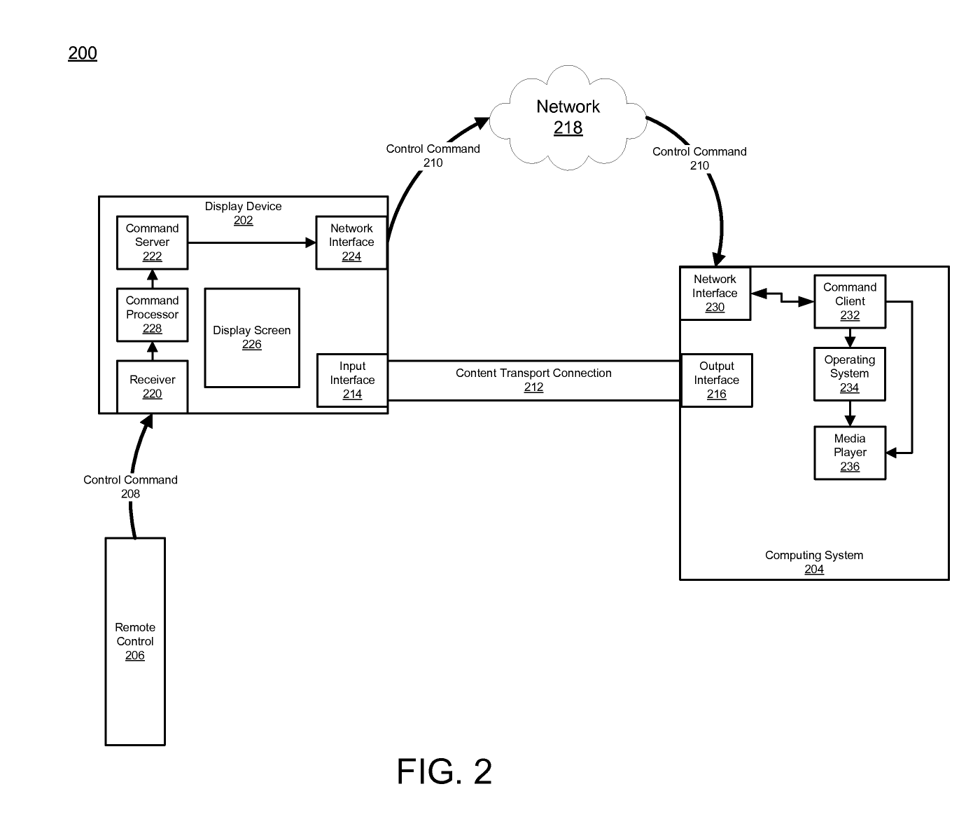

FIGS. 2-5 illustrate exemplary components used by various embodiments of the present invention. Although specific components are disclosed in systems 200-500 it should be appreciated that such components are examples. That is, embodiments of the present invention are well suited to having various other components or variations of the components recited in systems 200-500. It is appreciated that the components in systems 200-500 may operate with other components than other those presented, and that not all of the components of systems 200-500 may be required to achieve the goals of systems 200-500.

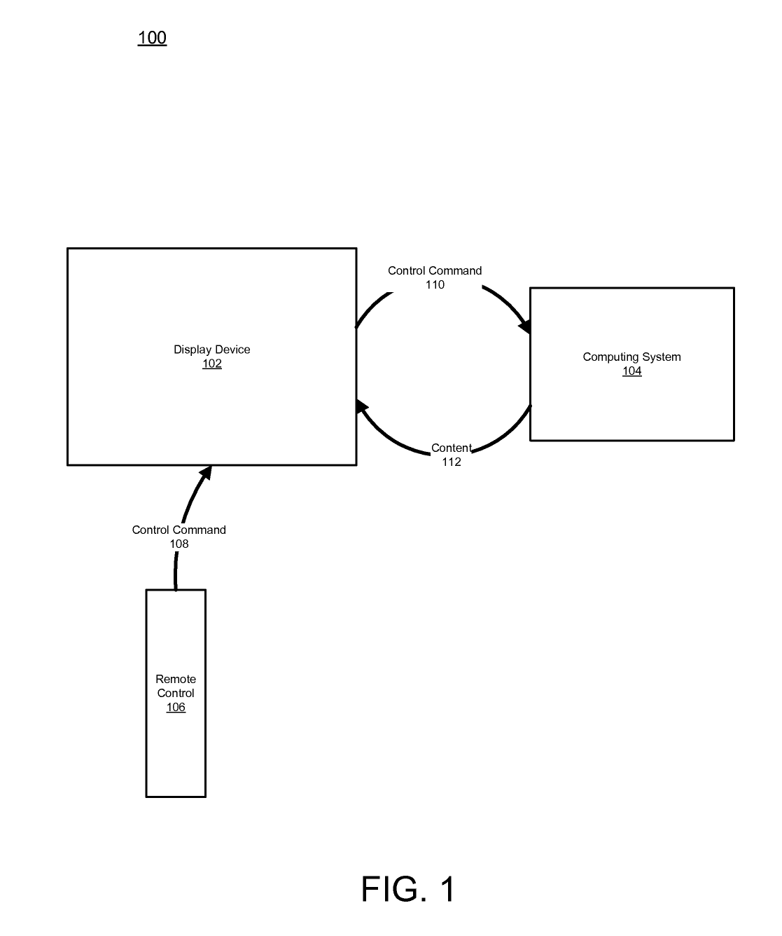

FIG. 1 shows an exemplary flow of commands and content in accordance with one embodiment of the present invention. Diagram 100 includes display device 102, computing system 104, and remote control 106. Remote control 106 can be any wireless control, e.g., an infrared or radio based wireless device.

Display device 102 may be of a variety of audio/video rendering and display devices including a television, Cathode Ray Tubes (CRTs), Liquid Crystal Displays (LCDs), plasma displays, projection based displays, projectors, and Digital Light Processing (DLP) displays, etc. Display device 102 is operable to receive commands from wireless remote control device 106. In one exemplary sequence, remote control 106 issues control command 108 to display device 102. Display device 102 then sends control command 110 to computing system 104 for execution of a playback command. Computing system 104 provides content 112 to display device 102. Control 110 controls the rendering of content on computing system 104. Command 110 can include a variety of playback commands including stop, play, pause, fast-forward, rewind, next item in a playlist, previous item in a playlist, volume up/down, and full screen mode, etc. A user viewing content from computing system 104 on display device 102 can thus control the rendering of the content with remote control 106 without directly, physically interacting with user interface devices of the computing system 104.

Content 112 may be from a variety of sources including Moving Picture Experts Group (MPEG) video, MPEG2 video, Windows Media Video, Blu-ray discs, DVD discs, streaming video, streaming music, Quicktime video, MPEG3 music, MPEG4 video, or any digital source or format, etc. Content 112 may be rendered (e.g., played) on computing system 104 with a variety of software applications including audio players, video players, music players, picture viewers, portal players, VLC media player by the VideoLAN project, Windows Media Player by Microsoft Corporation of Redmond, Wash., Quicktime Player, iTunes by Apple Corporation of Cupertino, Calif., RealPlayer by RealNetworks of Seattle, Wash., etc. Content 112 may be sent to display device 102 from computing system 104 by a variety of communication connections including HDMI (High-Definition Multimedia Interface), DisplayPort, DVI (Digital Visual Interface), VGA, S-video, component, composite, or Syndicat des Constructeurs d'Appareils Radiorécepteurs et Téléviseurs, Radio and Television Receiver Manufacturers' Association (SCART), etc.

FIG. 2 shows exemplary components for remote media player control in accordance with one embodiment of the present invention. Diagram 200 includes wireless remote control 206, display device 202, network 218, content transport connection 212, and computing system 204.

Computing system 204 includes output interface 216, network interface 230, command client 232, operating system 234, and media player 236. Computing system 204 outputs digital content via output interface 216 over content transport connection 212 to input interface 214 of display device 202. Content transport connection 212 may be of a variety of different types of cables operable for carrying an audio/video signal to display device 202 including HDMI, DisplayPort, DVI, VGA, S-video, component, composite, or SCART, etc.

Display device 202 includes receiver 220, command server 222, network interface 224, input interface 214, and display screen 226. Remote control 206 is operable to issue control command 208 to display device 202. Remote control 206 may be based on a variety of wireless technologies including infrared and radio frequency technologies. Receiver 220 of display device 202 receives control command 208. Receiver 220 may be capable of receiving signals in a variety of ways including infrared and radio frequency transmission.

Receiver 220 then sends control command 208 to command processor 228. Command processor 228 determines, based on control command 208, whether the command should be sent to command server 222. Remote control 206 may also control display device 202. Command server 222 may translate the command 208 to a command recognized by the media player 236 and then send the control command 210 via network interface 224 over network 218 to computing system 204. Network 218 may be any of a variety of networks including wired networks (e.g., Ethernet) and wireless networks (e.g., 2.4 Ghz, 802.11a/b/g/n, Bluetooth, WiMax, etc.).

Computing system 204 receives control command 210 via network interface 230 which is used by command client 232 to receive the command. Command client can then send the command to media player 236 either via operating system 234 or directly to media player 236. Upon receiving control command 210, media player 236 implements the command and modifies the rendering of content which is thereby reflected as the rendered content is sent via output interface 216 to display device 202. In one embodiment, command client 232 identifies media player 236 and translates control command 210 to an appropriate control command for media player 236, assuming the command was not already translated by command server 222. Using the system of FIG. 2, a viewer can use remote control 206 to control display device 202 and also control the playback of digital content sourced from computing system 204 without physically interacting with the system 204.

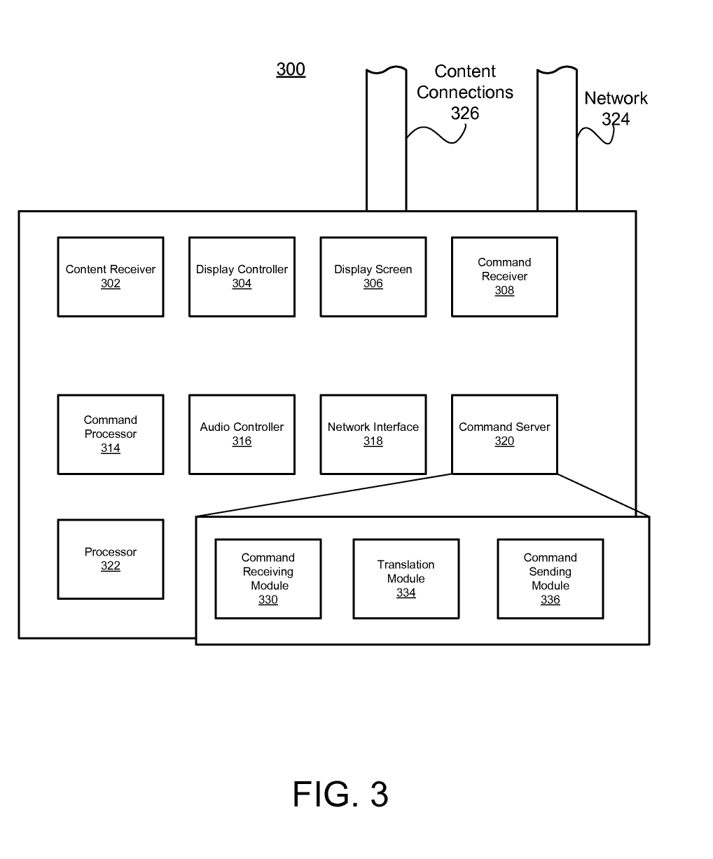

FIG. 3 shows exemplary components of a display device in accordance with one embodiment of the present invention. System 300 includes content receiver 302, display controller 304, display screen 306, command receiver 308, command processor 314, audio controller 316, network interface 318, command server 320, and processor 322. Processor 322 is operable to execute or otherwise carryout functions of components of system 300.

Content receiver 302 receives content via content connections 326 for system 300. Content receiver 302 may receive signals including content from a variety of sources including, but not limited to, computers, computer networks, portable devices, set top boxes, over the air broadcasts, cable broadcasts, satellite broadcasts, Digital versatile Discs (DVDs), Blu-ray discs, Digital Video Broadcasting-Handheld (DVB-H), Digital Multimedia Broadcasting (DMB), Digital Video Broadcasting Satellite services to Handhelds (DVB-SH), Digital Audio Broadcasting (DAB), Digital Video Broadcasting IP Datacasting (DVB-IPDC), Internet Protocol Television (IPTV), etc. Content receiver 302 may also receive electronic programming guide information. Content connections 326 may include a variety of connection types including HDMI (High-Definition Multimedia Interface), DisplayPort, DVI (Digital Visual Interface), VGA, S-video, component, composite, SCART, cable, and satellite, etc.

Display controller 304 controls display screen 306 of system 300. Display controller 304 may control a variety of display screens types associated with system 300, including CRTs, LCDs, plasma displays, projection based, and DLP displays, etc.

Command receiver 308 receives remote control commands for system 300. Command receiver 308 may receive commands via a variety of technologies including optical receiver and radio frequency. The commands may have been issued via a remote control device (e.g., remote control 106 of FIG. 1). Command receiver 308 is operable to send the commands to command processor 314.

Command processor 314 processes commands received from command receiver 308. Command processor 314 is operable to send commands to command server 320 based on the type of content connection being used to receive content or process the command based on the command format. For example, certain commands such as content rendering commands (e.g., stop, play, pause, fast-forward, rewind, next item in playlist, previous item in playlist, volume up/down, and full screen) are sent to command server 320 when certain content connections are being used to receive and display content (e.g., HDMI, S-video, VGA, and DisplayPort). In one embodiment, whether and which commands are sent to command server 320 is a programmable feature. Certain other commands (e.g., change channel, EPG selection, launch menu, change input, etc.) may be received by via an infrared receiver or radio frequency receiver, decoded, and processed by command processor 314.

Audio controller 316 controls audio output for system 300 including a variety of outputs including, but not limited to 2, 2.1, 3.1, 5.1, 6.1, 7.1, and 8.1 channel audio. The audio content may be received via content receiver 302. It is appreciated that audio controller 316 may output to audio equipment integrated within system 300.

Command server 320 is operable to send commands out via network interface 318 over network connection 324 based on commands received from command processor 314. Command server 320 includes command receiving module 330, translation module 334 and command sending module 336. Command receiving module 330 is operable to receive commands from command processor 314 and provide the commands to translation module 334. Translation module 334 translates commands received from command processor 314 to a command recognizable via a remote media player control application in a separate computer system. In one embodiment, translation module 334 converts a remote control code into a content rendering control command. Translation module 334 provides the command to command sending module 336. Command sending module 336 is operable to prepare the command for sending over a network (e.g., TCP/IP based network) via network interface 318. For example, the IP address of the separate computing system may be entered into the display device or determined based on a discovery mechanism. In one embodiment, command sending module 336 prepares the command for transmission based on the network type (e.g., packetizing the command for a TCP/IP based network). In another embodiment, command sending module 336 prepares the command for receipt by a Hypertext Transfer Protocol (HTTP) based module.

FIG. 4 shows exemplary components of an operating environment for control of a media player application of a computer system in accordance with one embodiment of the present invention. An exemplary system for implementing embodiments includes a general purpose computing system environment, such as computing system environment 400. Computing system environment 400 may include, but is not limited to a server, desktop computer, laptop, netbook, tablet PC, mobile device, or smartphone. In its most basic configuration, computing system environment 400 typically includes at least one processing unit 402 and memory 404. Depending on the exact configuration and type of computing system environment, memory 404 may be volatile (such as RAM), non-volatile (such as ROM, flash memory, etc.) or some combination of the two.

System memory 404 may include, among other things, Operating System 418 (OS), application(s) 420, and remote media player control client application 422. Remote media player control client application 422 facilitates remote control of media player 424. For example, remote media player control client application 422 allows control of media player 424 from a remote control (e.g., remote control 106) via a display device (e.g., display device 102). It is appreciated that the media player 424 may also be directly controlled via direct interaction with input device(s) 414 of system 400.

Additionally, computing system environment 400 may also have additional features/functionality. For example, computing system environment 400 may also include additional storage (removable and/or non-removable) including, but not limited to, magnetic or optical disks or tape. Such additional storage is illustrated in FIG. 4 by removable storage 408 and non-removable storage 410. Computer storage media includes volatile and nonvolatile, removable and non-removable media implemented in any method or technology for storage of information such as computer readable instructions, data structures, program modules or other data. Memory 404, removable storage 408 and nonremovable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 400. Any such computer storage media may be part of computing system environment 400.

Computing system environment 400 may also contain communications connection(s) 412 that allow it to communicate with other devices. Communications connection(s) 412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 412 may allow computing system environment 400 to communication over various networks types including, but not limited to, Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 412 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 400 may also have input device(s) 414 such as a keyboard, mouse, pen, voice input device, touch input device, remote control, etc. Output device(s) 416 such as a display, speakers, etc. may also be included. All these devices are well known in the art and need not be discussed at length here.

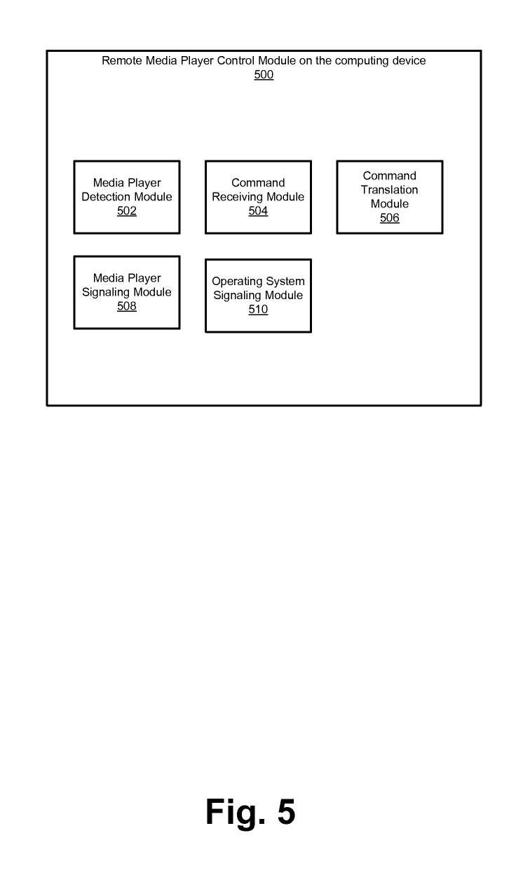

FIG. 5 shows exemplary components of a remote media player control module in accordance with one embodiment of the present invention. Remote media player control module 500 may be part of a remote media player control client application (e.g., remote media player control client application 422). In one embodiment, remote media player control module 500 is part of a client application (e.g., command client 232).

Remote media player control module 500 includes media player detection module 502, command receiving module 504, command translation module 506, media player signaling module 508, and operating system signaling module 510. Media player detection module 502 is operable to detect or determine an active media player application (e.g., media player 424). Command receiving module 504 is operable to receive a content rendering control command (e.g., from command server 222) and provide the command to command translation module 506.

Command translation module 506 may translate the command, based on the media player application determined to be active by media player detection module 502, to a command to be performed by the active media player. Command translation module 506 then uses media player signaling module 508 or operating system signaling module 510 to send the command to the active media player application. In one embodiment, media player signaling module 508 directly signals the active media player application (e.g., media player 424). In another embodiment, operating system signaling module 510 is sent a command and sends the translated control command to the active media player application.

In one embodiment, media player signaling module 508 is operable to signal a media player application to bring an active media player application to the forefont (e.g., bring the media player application in front of other application windows) prior to signaling the media player application. In one embodiment, media player signaling module 508 is operable to select a media player application from among multiple executing media player applications based on a priority scheme. For example, media player signaling module 508 may check a default media player application (e.g., Windows Media Player) first and if the default media player application is not active (e.g., not rendering content) then media player signaling module 508 checks other media player applications to determine which media player application is active. The media player application determined to be active can then be signaled.

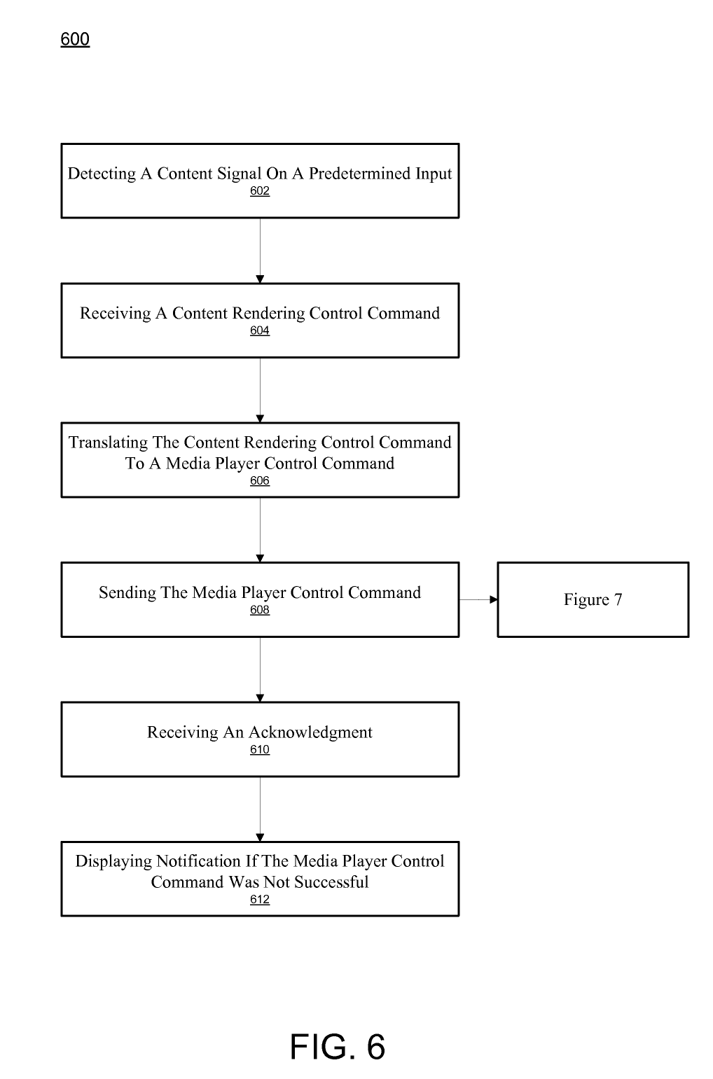

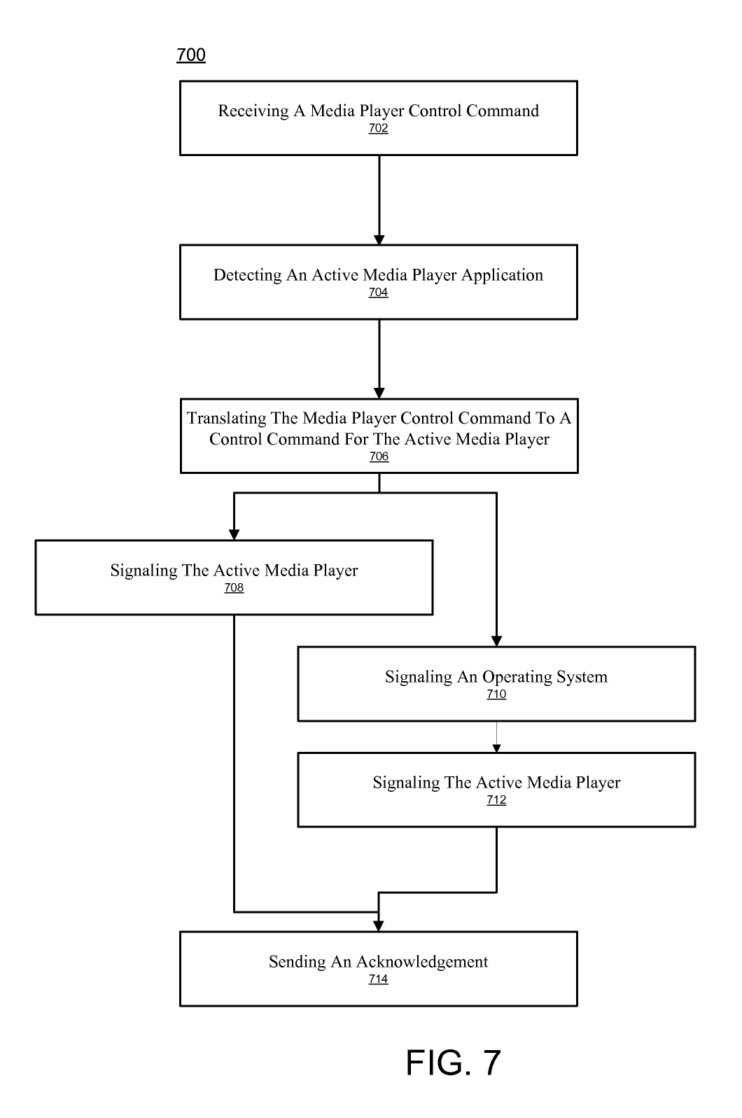

With reference to FIGS. 6 and 7, flowcharts 600-700 illustrate example functions used by various embodiments of the present invention. Flowcharts 600-700 include processes that, in various embodiments, are carried out by processors under the control of computer-readable and computer-executable instructions which may be stored on a computer-readable medium. Although specific function blocks (“blocks”) are disclosed in flowcharts 600-700, such steps are examples. That is, embodiments are well suited to performing various other blocks or variations of the blocks recited in flowcharts 600-700. It is appreciated that the blocks in flowcharts 600-700 may be performed in an order different than presented, and that not all of the blocks in flowcharts 600-700 may be performed.

FIG. 6 shows a flowchart of an exemplary process for receiving a control command in accordance with one embodiment of the present invention. In one embodiment, process 600 is performed by an audio/video display device (e.g., display device 102). Process 600 may be performed by a command server (e.g., command server 222).

At block 602, a content signal on a predetermined input is detected. As described herein, content being received on a predetermined input (e.g., HDMI, S-video, VGA, and DisplayPort) connected to a computing system is detected. In one embodiment, upon detecting content being received a predetermined input then commands may be sent to the computing system.

At block 604, a content rendering control command is received from a remote control device. As described herein, the content rendering control command may be a command operable for controlling content rendering or media playback (e.g., stop, play, pause, fast-forward, rewind, full screen, next playlist item, previous playlist item, full screen, volume up/down, next photo, previous photo commands, etc.).

At block 606, the content rendering control command is translated into a media player control command. As described herein, the content rendering control command may be translated from a remote control code to a command for a media player application.

At block 608, the media player control command is sent. As described herein, the media player control command may be sent to the computing system (e.g., over a communication network). The process of FIG. 7 may then be performed based on the media player control command.

At block 610, an acknowledgment is received. The acknowledgement may indicate that the command was successfully received and performed by a media player application.

At block 612, a notification is displayed if the media player control command was not successful. In one embodiment, a notification that the media player control command was not successful may be displayed after a timeout period.

FIG. 7 shows a flowchart of an exemplary process for media player control in accordance with one embodiment of the present invention. In one embodiment, process 700 is performed by a computing system (e.g., computing system 104). Process 700 may be performed by a command client (e.g., command client 232).

At block 702, a media player control command is received at the computer system. As described herein, the media player control command may be received from a display device.

At block 704, an active media player application is detected. In one embodiment, an active media player application is detected via an operating system.

At block 706, the media player control command may be translated to a control command for the active media player. As described herein, the media player control command is translated based on the active media player detected to the computer system.

At block 708, the active media player is signaled. In one embodiment, the active media player is signaled by a remote media player control application (e.g., remote media player control client application 422).

At block 710, an operating system is signaled. As described herein, the media player control command may be sent to the operating system for delivery to the active media player.

At block 712, the active media player is signaled. As described herein, the active media player may be signaled by an operating system (e.g. via an operating system API). The active media player then performs the playback command specified by the received command.

At block 714, an acknowledge is sent. As described herein, an acknowledgement may be sent that the control command was successful performed.

In this fashion, embodiments of the present invention allow for control of content rendering by a computing system from a remote control. Controlling content rendering from the remote control removes the need for a viewer to physically go over to the computer to alter the playback thereby providing an optimal viewing experience. Embodiments of the present invention further provide greater ease of use than using the cursor device directly of the computer system (e.g., a computer mouse).

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of controlling content rendering comprising:
rendering at a display device a content signal received on a predetermined input and sourced from a computer system;
receiving at said display device a content rendering control command from a remote control device;
translating said content rendering control command to a media player control command recognizable by a media playback application of said computer system; and
sending said media player command to said computer system over a communication network to alter said content signal.

2. The method of claim 1 wherein said predetermined input is a High-Definition Multimedia Interface (HDMI) input.

3. The method of claim 1 wherein said predetermined input is a Video Graphics Array (VGA) input.

4. The method of claim 1 wherein said predetermined input is a S-video input.

5. The method of claim 1 wherein the content rendering control command comprises a remote control command code.

6. The method of claim 1 wherein said content rendering control command comprises at least one of a stop, play, pause, fast-forward, and rewind command.

7. The method of claim 1 wherein said content rendering control command comprises a full screen command.

8. The method of claim 1 wherein said content rendering control command comprises at least one of a next playlist item command and a previous playlist item command.

9. The method of claim 1 further comprising:
receiving an acknowledgment signal indicating that said media playback application performed said media player command.

10. The method of claim 1 further comprising:
displaying a notification if the media player control command was not successful.

11. A system for remote media player control comprising:
a media player detection module operable to detect an active media player application;
a command receiving module operable to receive a media player control command from a display device which originated from a remote control device;
a command translation module operable to translate said media player control command to a control command for said active media player application; and
a media player signaling module operable to send said control command to said active media player application for execution thereof.

12. A system as described in claim 11 wherein said command receiving module is operable to receive said media player control command via at least one of a wired computer network and a wireless computer network.

13. A system as described in claim 11 further comprising:
an operating system signaling module operable to send said control command to an operating system.

14. A system as described in claim 11 wherein said media player signaling module is operable to send said control command to said active media player application via an operating system call.

15. A computer readable media comprising instructions that when executed by an electronic system implement a method of remote control of content rendering, said method comprising:
detecting, within a display device, a content signal received on a predetermined input and sourced from a computer system;
receiving a content rendering control command from a remote control device;
translating said content rendering control command to a media player control command recognizable by a media playback application of the computer system; and
sending said media player command to the computer system over a network to alter said content signal.

16. The computer readable media of claim 15 wherein said predetermined input is a Video Graphics Array (VGA) input.

17. The computer readable media of claim 15 wherein said predetermined input a High-Definition Multimedia Interface (HDMI) input.

18. The computer readable media of claim 15 wherein said network is at least one of a wireless network and a wired network.

19. The computer readable media of claim 15 wherein said content rendering control command comprises at least one of a stop, play, pause, fast-forward, and rewind command.

20. The computer readable media of claim 15 wherein said content rendering control command comprises a full screen command.
